(19) United States
(12) Patent Application Publication
(10) Pub. No.: US 2018/0171274 A1
(43) Pub. Date: Jun. 21, 2018

(54) ADDITION OF INGREDIENTS HAVING AROMATIC COMPONENTS TO A BEVERAGE

(71) Applicant: Barrel Brothers Brewing Company, LLC, Windsor, CA (US)

(72) Inventor: Wesley Deal, Santa Rosa, CA (US)

(21) Appl. No.: 15/844,048

(22) Filed: Dec. 15, 2017

Related U.S. Application Data
(60) Provisional application No. 62/435,030, filed on Dec. 15, 2016.

(51) Int. Cl. C12C 13/00; C12C 11/00

(52) U.S. Cl. CPC C12C 13/00; C12C 11/00

(57) ABSTRACT

A method for dry hopping a beverage such as young beer includes the steps of removing a portion of the beverage from the fermentation tank, mixing it with hops in a mixing vessel having a rotating paddle, and returning the young beer to the fermentation tank. A system and a mixing device are disclosed that are suitable for use with the method.

### CROSS-REFERENCE TO RELATED APPLICATION

This non-provisional patent application claims benefit and priority under 35 U.S.C. § 119(e) of U.S. provisional patent application Ser. No. 62/435,030, filed on Dec. 15, 2016, and titled “Addition of Ingredients having Aromatic Components to a Beverage,” the contents of which are incorporated herein by reference for all purposes.

### BACKGROUND

The production of craft beer often requires dry hopping, a process in which hops, the flowers or seed cones of the hop plant Humulus lupulus, are added to beer at the cold stages, such as after fermentation or in the final stages of fermentation of the beer. The volatile oils from the addition of hops at an earlier stage of brewing will be lost during the boiling of the hopped wort or through the vented CO₂ created during fermentation. The addition of hops to the beer after or late in the process of brewing therefore prevents the volatile hops oils from being driven off and lost to the atmosphere.

Dry hopping usually involves the addition of dry hops directly to the fermentation tank in the form of pellets or whole cone hops. The addition of the hops to the beer improves certain aromatic qualities of the beer or adds such qualities by solubilizing hop oils of different types into the beer. This imparts varying levels of aromatic molecules to the beer.

In the classic method of dry hopping the brewer drops the hops into the top of a fermentation tank containing the fermented or young beer or injects the hops through a port in the side of the tank. The hops percolate and settle in the bottom of the fermentation tank until the brewer decides to dump the spent hops through a bottom tank valve or rack the beer off into a separate vessel.

The shortcomings of the classical dry hopping method are apparent to today's more discerning and innovative brewer. Beer dry hopped by the classical method can have a crude and more vegetal aroma. In addition, the aging times of classically dry hopped beer will increase. Increasing the time for dry hopping not only decreases total production capacity, but also decreases the overall freshness of the finished product by increasing the time from production to consumption and by allowing the beer to be exposed to destructive oxygen and ultraviolet light when the fermentation tank is opened to add dry hops.

The classical method of dry hopping has other disadvantages for the brewer by creating many uncontrollable and undesirable variables. The settling of hops on the bottom of a tank reduces the surface area presented by a given volume of hops. Scientific studies indicate that this decreases the diffusion rate of the available hop oils into the surrounding beer. Therefore additional time must be provided to allow the available hop oils to become soluble and diffuse from the hops into the beer. The necessary increase in contact time slows production rates. It also allows less desirable polyphenols to be solubilized from the hops into the beer and thus creating a harsher plant flavor.

Alternative dry hopping methods and devices are known that seek to provide the benefits of dry hopping without exposing the young beer to oxygen, ultraviolet light, or other elements such as bacteria. This can be done by inserting hops into the fermentation tank without any exposure to the atmosphere or light or by removing young beer from the fermentation tank, mixing it with hops, and returning the mixed hops and young beer to the fermentation tank.

For example, the “hops cannon” method involves propelling hops from an exterior supply vessel into the fermentation tank. The exterior supply vessel, the fermentation tank, and a connecting hose are sealed from the ambient atmosphere. For example, U.S. Pat. No. 9,303,241 to Reeves for an “Apparatus, System, and Method for Adding Hops or Other Ingredients to Beverage” describes equipment and a method for dry hopping in which the reservoir of the external supply vessel or “hops cannon” is sterilized, pelletized hops are placed in the hops cannon, atmospheric gases are purged from the hops cannon with carbon dioxide, the pelletized hops are moved under pressure of carbon dioxide to a sight glass under the hops cannon reservoir, and then the pelletized hops are discharged through an outlet hose to the inlet pipe of a fermentation tank containing a beverage such as young beer. The Reeves method will result in the addition of hops to the fermentation tank, where they will settle with the problems noted for classic dry hopping, albeit with no exposure of the added hops or the young beer in the fermentation tank to the atmosphere, light, or bacteria.

Another method of dry-hopping grinds and mixes hops with young beer from the fermentation tank in an external apparatus and then returns the mixture of young beer and ground hops to the fermentation tank, without exposing either the hops or the young beer to the atmosphere, light, or bacteria. U.S. Pat. No. 8,875,616 B2 to Roth for “Facility for Introducing Hop into a Tank” describes a facility for carrying out such a method including a hop-receiving tank that can be hermetically sealed with an outflow and an inert gas supply at its bottom. Hops pass from the receiving tank to a mixing apparatus where they are ground and at the same time mixed with young beer from the fermentation tank. The hop-young beer mixture is immediately returned to the fermentation tank. The Roth method will result in the addition of ground hops to the fermentation tank, where they will settle with the issues noted for classic dry hopping, albeit with no exposure of the added hops or the young beer in the fermentation tank to the atmosphere, light, or bacteria.

Another method for dry hopping is intended to extract aroma substances from hops without requiring the extraction of spent hops or hop trub particles from the beer when it is in the fermentation tank. U.S. patent publication 2016/0145550 A1 to Bahns, et al. for “Device and Method for Extracting Aroma Substances from Vegetable Aroma Carriers into a Brewing Liquid” describes a method of dry-hopping that passes a brewing liquid from the fermentation tank through an external fluidized bed extractor containing solid particles formed from “vegetable aroma carriers” or hops. The feeding speed of a feed pump is set at a value at which the average vertical feeding speed of the brewing liquid in the fluidized bed extractor is lower than the average vertical sedimentation speed of the solid particles. The solid particles will be retained in the suspension bed when the brewing liquid is being fed upwardly through the fluidized bed extractor. The direct contact of the brewing liquid with the solid hop particles causes the soluble aroma components to be released from the particles.

The Bahn, et al. method requires a number of steps that would have to be performed precisely in order to maintain the suspension bed. The apparatus is complicated and expensive, with an elaborate number of valves, filters, pumps, and pipes. The brewing liquid is in constant motion during the performance of the method.

Better control of the dry hopping process is needed than the classical dry hopping method provides. Simple apparatus and methods, however, are needed in order to satisfy the demands of commercial beer making and in particular craft brewing.

In addition to adding dry hops to beer, the brewer may wish to introduce other ingredients or adjuncts into the beer. The 500 year old German purity regulation, the Reinheitsgebot, requires that the “only ingredients used for the brewing of beer must be Barley, Hops, and Water.” Yeast is implicitly included in this list of ingredients in order to ferment the (malted) barley although the purpose of yeast was unknown before Pasteur's discoveries concerning fermentation (published in 1858). Adjuncts therefore are ingredients added to beer that are not water, barley (malted), hops, or yeast. Examples of an adjunct that could be added to beer after fermentation are flavor enhancers such as spices, herbs, extracts, fruits, and similar ingredients.

A simple and low-cost method and apparatus for treating beer with adjuncts without exposing the adjuncts or the beer to atmospheric oxygen is needed.

Aromatic ingredients also may be added in the production of other beverages such as cider or fermented fruit juice. A simple and low-cost method and apparatus for treating ciders or other beverages with aromatic ingredients without exposing the aromatic ingredients or the beverages to atmospheric oxygen is needed.

### SUMMARY

An aspect of the disclosed subject matter is a method of adding hops or other ingredients (such as adjuncts) to a beverage, such as fermented beer or young beer or cider, in a mixing vessel at a speed, frequency, and duration of the brewer's choosing and without exposing the hops or other ingredients and the beverage to the atmosphere or light. The active mixing of the hops or other ingredients in the beverage represents a stirred system resulting in higher overall aroma compound extraction. The mixture of hops or other ingredients with the beverage is sent to a tank, such as a fermentation tank, to add the mixture's aroma compounds to the fermented beer or cider present in the tank.

In accordance with an aspect of the disclosed subject matter, a method of dry hopping allows the brewer to mix hops and fermented beer or young beer in a mixing vessel at a speed, frequency, and duration of the brewer's choosing without exposing the hops or fermented beer or young beer to the atmosphere or light. The mixture of hops and fermented beer or young beer is sent to a fermentation tank to add the mixture's aroma compounds to the fermented beer or young beer present in the fermentation tank.

In accordance with another aspect of the disclosed subject matter, a method of adding an adjunct to a beverage such as new beer or a cider allows the brewer to mix the adjunct with the beverage in a mixing vessel at a speed, frequency, and duration of the brewer's choosing without exposing the adjunct or the beverage to the atmosphere or light. The mixture of adjunct and beverage is sent to a fermentation tank to add the mixture's aroma compounds to the beverage present in the fermentation tank.

In accordance with yet another aspect of the disclosed subject matter, a mixing vessel is provided that mixes hops or other ingredients, such as adjuncts, with a beverage such as fermented beer or cider received from a fermentation tank. The hops or other ingredients and the beverage are stirred in the vessel with a paddle until the hops or other ingredients have provided desired characteristics such as aromatics to the beverage. The beverage in the mixing vessel is then returned to the fermentation tank to mix with the beverage remaining in the fermentation tank after the vessel was filled.

An embodiment of the mixing vessel is a cylinder with an internal paddle mechanism that can be turned by a hand crank or with a motor. The vessel preferably mounted on a frame so that the axis of the cylinder is horizontal or parallel to the ground although other configurations are possible. The frame is provided with wheels for easy transporting and positioning around the brewing cellar. The vessel preferably has a top and a bottom sanitary port allow for filling, emptying, and cleaning. Appropriate valves, fittings, and gauges allow for the device to be pressurized. A funnel attachment can be fixed to the top port to allow for hops or other ingredients to be dumped inside the mixing vessel. A clean-in-place (CIP) spray ball can also be attached to the top port for cleaning.

Additional features, advantages, and embodiments of the disclosed subject matter may be set forth or apparent from consideration of the following detailed description, drawings, and claims. Moreover, it is to be understood that both the foregoing summary of the disclosed subject matter and the following detailed description are exemplary and intended to provide further explanation without limiting the scope of the disclosed subject matter as claimed.

### BRIEF DESCRIPTION OF THE DRAWINGS

These and other aspects of the disclosed subject matter will become clear from the following description with reference to the accompanying drawings, wherein:

FIG. 1 is a perspective view of an exemplary embodiment of a mixing vessel made in accordance with principles of the disclosed subject matter;

FIG. 2 is a side plan view of the mixing vessel shown in FIG. 1;

FIG. 3 is a side sectional view of the mixing vessel taken along its center axis;

FIG. 4 is a sectional view of the mixing vessel taken along the plane 4 as shown in FIG. 2;

FIG. 5A is a front view showing an exemplary embodiment of a system for dry-hopping beer in accordance with principles of the disclosed subject matter, in which the system is set up for purging the mixing vessel and related hoses;

FIG. 5B is a front view of the system shown in FIG. 5A in which the system is set up for loading the mixing vessel from a fermentation tank;

FIG. 5C is a front view of the system shown in FIG. 5A in which the system is set up for discharging the mixing vessel to the fermentation tank; and

FIG. 6 is a block diagram depicting an exemplary method in accordance with principles of the disclosed subject matter.

### DETAILED DESCRIPTION

The disclosed subject matter will be described in detail hereafter with reference to exemplary embodiments shown in the accompanying drawings. In this description, the specific ingredient having aromatic components is hops or hops pellets and the beverage is new or young beer, that is, beer that has been recently fermented and cooled. It will be understood that the methods, devices, and systems described below could be employed with other ingredients and beverages.

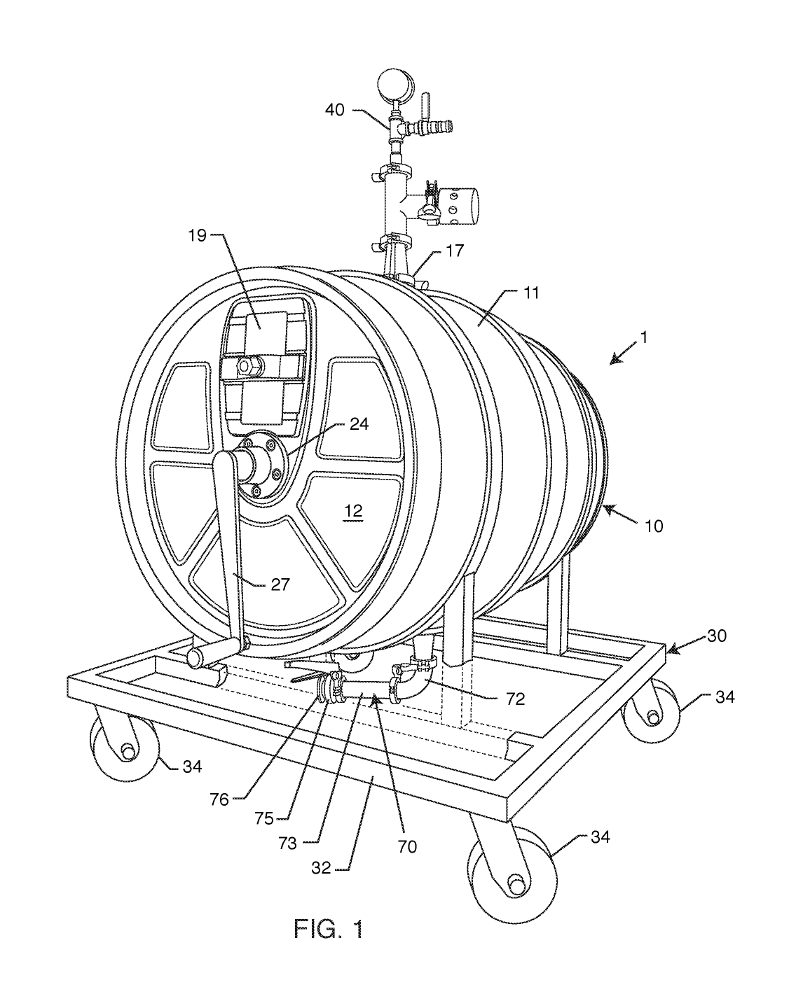

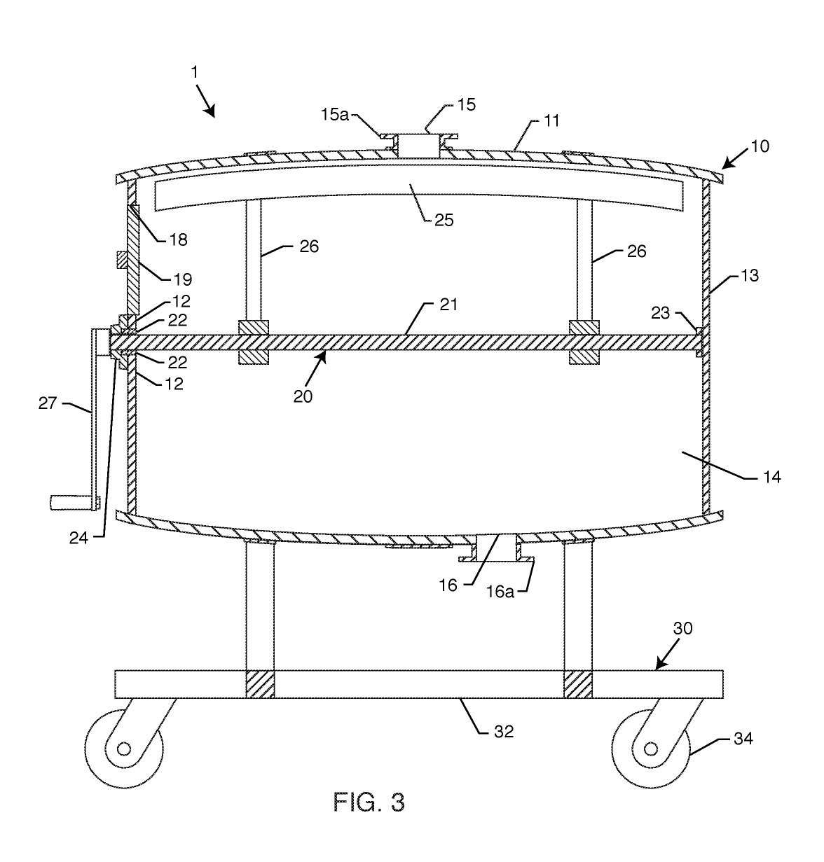

A currently preferred mixing device 1 according to the disclosed subject matter is shown in FIG. 1. The mixing device 1 has a mixing vessel 10 mounted on a cart 30 that is attached to and supported by wheels 34. Preferably, the wheels 34 are attached to the cart 30 so they can rotate about generally vertical axes, like caster wheels, for easier maneuverability. The mixing vessel 10 is shaped like a barrel with a generally cylindrical sidewall 11 joined to end walls 12 and 13 to define an interior compartment 14. The mixing vessel 10 is aligned on the cart 30 so the axis of the cylindrical sidewall 11 (and thus the compartment 14) is horizontal. The shaft 21 is located along the axis of the cylindrical sidewall 11 (see FIG. 3).

The mixing device 1 could have a mixing vessel 10 that has wheels attached directly to the vessel 10 in place of the cart 30, although this is not shown in the drawings.

The mixing vessel 10 preferably is made of stainless steel although other materials could be employed as long as they are strong to withstand pressurization as well as food-safe for sanitary reasons.

An upper port 15 is defined in the top of the sidewall 11. (“Top” and “bottom” for the purpose of this specification refer to positions on the sidewall 11 with respect to the floor supporting the cart 30.) A short cylinder with a circular flange 15a is attached (such as by welding) to the exterior of the sidewall 11 and above the port 15. The flange 15a is part of a tri-clamp or tri-clover sanitary fitting for detachable mating with use of the tri-clamp or tri-clover clamp 17 and a gasket (not shown) to corresponding flanges on various devices to be described below.

A bottom port 16 is defined in the bottom of the sidewall 11. A short cylinder with a circular flange 16a is attached (such as by welding) to the exterior of the sidewall 11 and below the port 16. The flange 16a is part of a tri-clamp or tri-clover sanitary fitting for detachable mating with use of a tri-clamp or tri-clover clamp and a gasket (not shown) to corresponding flanges on devices described below.

The mixing vessel 10 contains a mixing apparatus 20 that includes a paddle 25 that rotates within the compartment 14. An axle 21 is mounted between a bearing 22 attached to the end wall 12 and a bearing 23 attached to the end wall 13. The bearings 22 and 23 are aligned along the axis of the generally cylindrical sidewall 11 so the axle 21 occupies that axis. An end of the axle 21 is available to the outside of the mixing vessel 10 through an opening in the end wall 12. The handle 27 is detachably connected to the axis 21. The handle 27 can be manually turned so that the axle 21 rotates in the bearings 22 and 23.

Alternatively, the axle 21 may be connected to an electric motor (not shown) to turn the axle 21. The motor preferably would be attached to a power supply and a control system. The control system would be configured to turn the axle 21 and thus the paddle 25 according to a preset schedule.

The arms 26 are connected to the axle 21 and extend radially from the axle 21 to the paddle 25. The paddle 25 is generally parallel to the axle 21 and is both shaped and mounted at the ends of the arms 26 in such a way that the paddle 25 will be adjacent to but not contact the sidewall 11 when the axle 21 rotates. The paddle 25 as shown in the drawings is a flat blade configured to fit inside the walls 11, 12, and 13 that define the compartment 14 but other shapes are possible, such as a spiral.

An initial prototype of the mixing device 1 was constructed by adapting a Modern Cooperage® mixing barrel. Modern Cooperage® barrels are stainless steel barrels provided with a rotatable internal array that receives and mounts staves of oak (see www.moderncooperage.com). Their purpose is to age or mature wine by contacting it with the oak. In the past, barrels made of oak were used for wine maturation but the barrels needed to be replaced after use. The Modern Cooperage® barrels last longer because only the wood staves need to be replaced with each charge of wine. The following patents relate to the general concept but do not exactly depict the Modern Cooperage® mixing barrel used for the initial prototype: U.S. Pat. No. 7,284,476 B2 to Roleder for “Container Assembly for Aging a Liquid” and U.S. Pat. No. 9,032,864 B2 to Roleder for “Container Assembly for Aging a Liquid.”

The initial prototype of the mixing device 1 was constructed by adding a bottom port and bottom port flange to a Modern Cooperage® barrel and by providing one permanent stainless steel paddle in place of the various removable oak staves. The port 18 on the end wall 12, originally provided for accessing the compartment 14 in order to remove and replace oak staves, is useful for providing a vent when the vessel 10 is being cleaned. (When using high-temperature cleaning chemicals the vessel 10 should be vented to avoid excessive positive or negative pressures that could compromise the integrity of the vessel 10.)

A cart 30 with wheels 34 was welded to the modified Modern Cooperage® barrel so the mixing device 1 could be readily moved to be adjacent a fermentation tank or any other place the mixing device 1 is needed. The mixing device 1 also can be easily moved to a storage position that is out of the way of normal brewery operations.

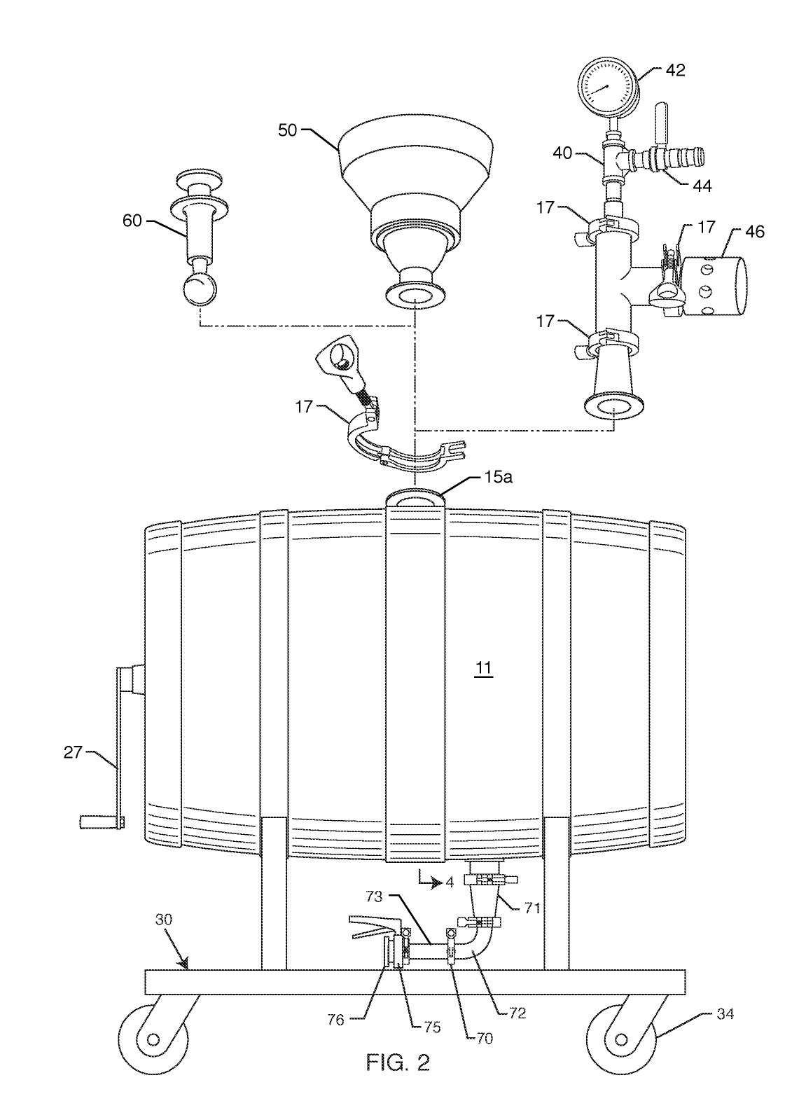

The top port 15 may receive or attach to a number of devices as indicated in FIG. 2. One is the pressure system 40, consisting of a pressure gauge 42, a CO₂ valve 44, and a pressure relief valve 46. The pressure system 40 both supplies carbon dioxide to the compartment 14 and releases pressure in that compartment.

Another device that may be attached to the top port 15 is a funnel 50. The funnel 50 may be inserted and connected to the top port 15 in order to load hops or hops pellets, or adjuncts, into the compartment 14.

Yet another device that may be attached to the top port 15 is a clean-in-place (CIP) spray ball 60. The CIP spray ball 60 may be inserted into the top port 15 in order to supply cleaning liquid and water to clean the compartment 14. The pressure system 40, funnel 50, and CIP spray ball 60 all have flanges that are detachably connected to the flange 15a and are secured in place by the tri-clamp 17.

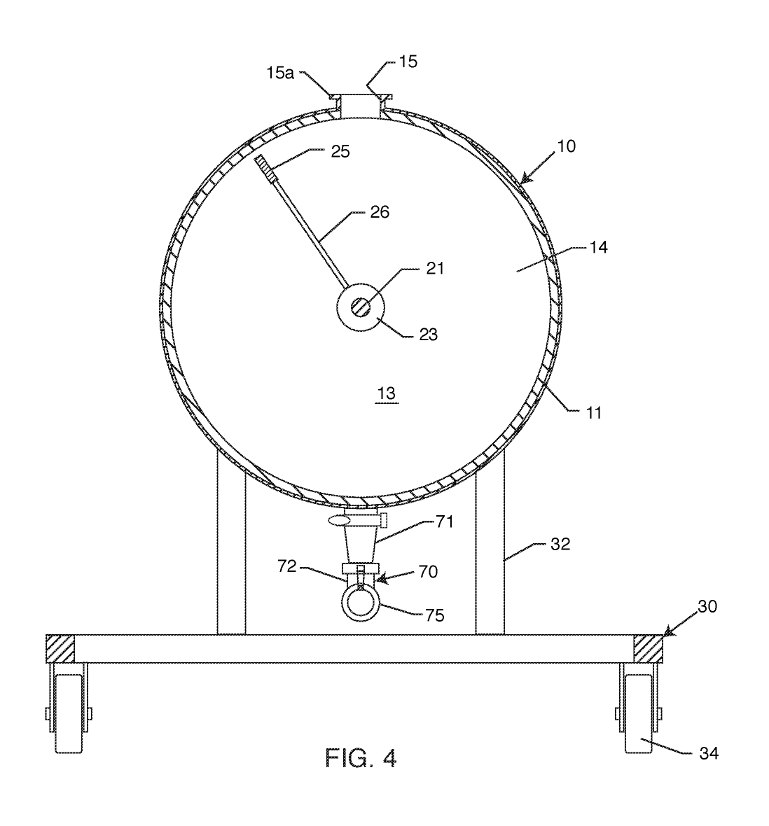

The bottom port 16 is equipped with a flange 16a. The flange 16a may be connected to a bottom access pipe system 70 that permits connection by a separate hose or pipe to a fermentation tank 100. As seen in FIGS. 1, 2, 4, 5A, 5B, and 5C, the bottom access pipe system 70 is composed of a reduction pipe 71, an elbow 72, the extension pipe 73, and concluding in the valve 75 that terminates in a connection flange 76. The segments 71-73 and the valve 75 have flanges that are held together with tri-clamps. The bottom access pipe system 70 may be removed from the bottom port 16 by disconnecting it from the flange 16a by loosening a tri-clamp.

The vessel 10 of the currently preferred version of the mixing device 1 is generally cylindrical and is mounted on the cart 30 so the axis of the generally cylindrical vessel is horizontally aligned with the paddle 25 rotating about the axle 21. Alternative versions of the mixing device could employ different shapes and orientations of the vessel 10. For example, the axle 21 could be vertically aligned in the manner of the impeller in a cylindrical-conical fermentation tank. The vessel 10 should have a bottom port adapted for draining the hops slurry and the beverage after mixing of the beverage and the hops. The paddle 25 should be adapted to stir the hops into the beverage rather than leaving the hops on the bottom of the compartment 14.

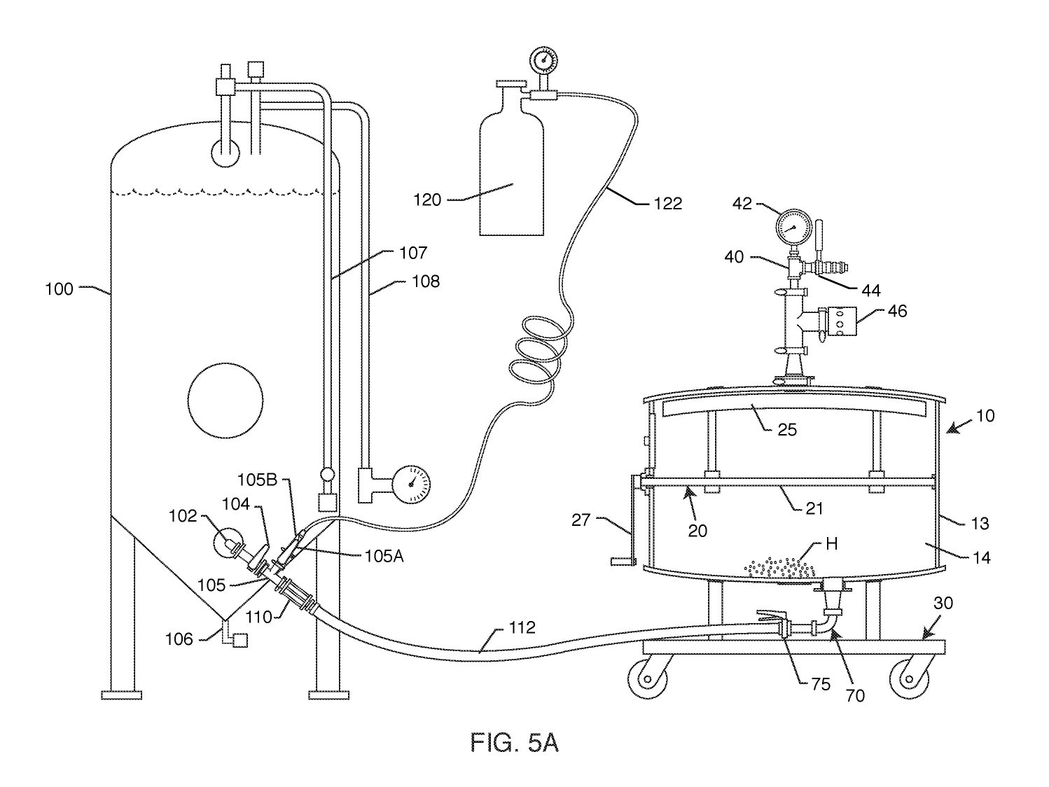

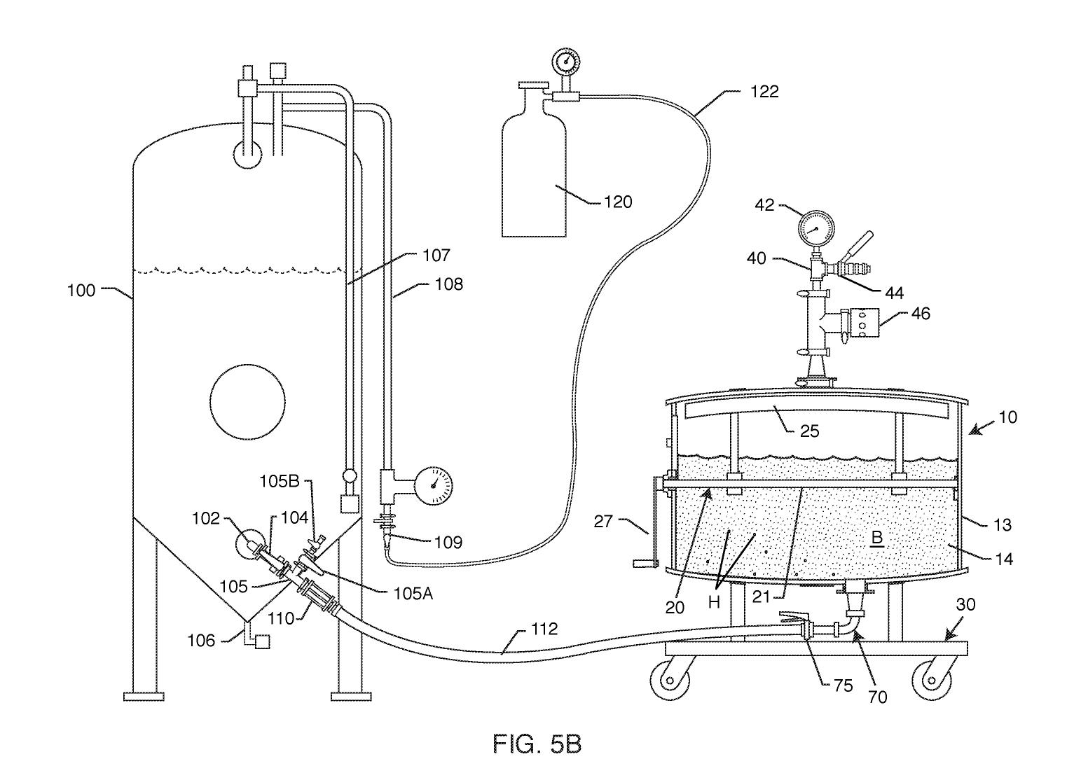

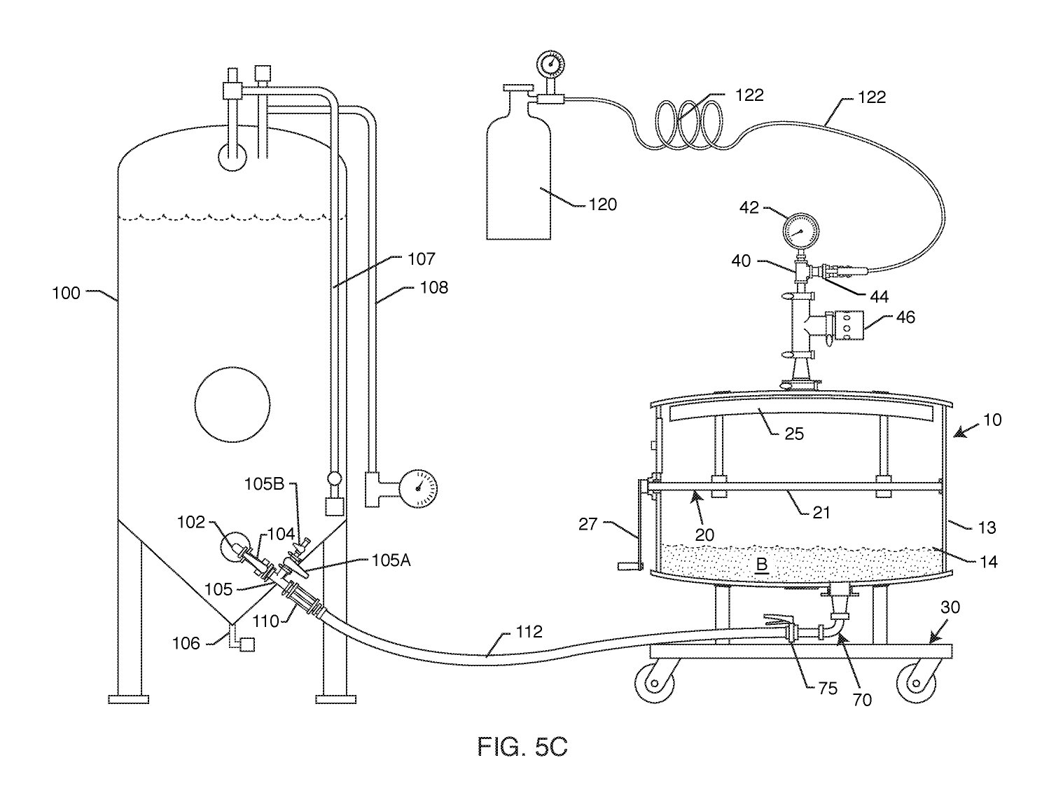

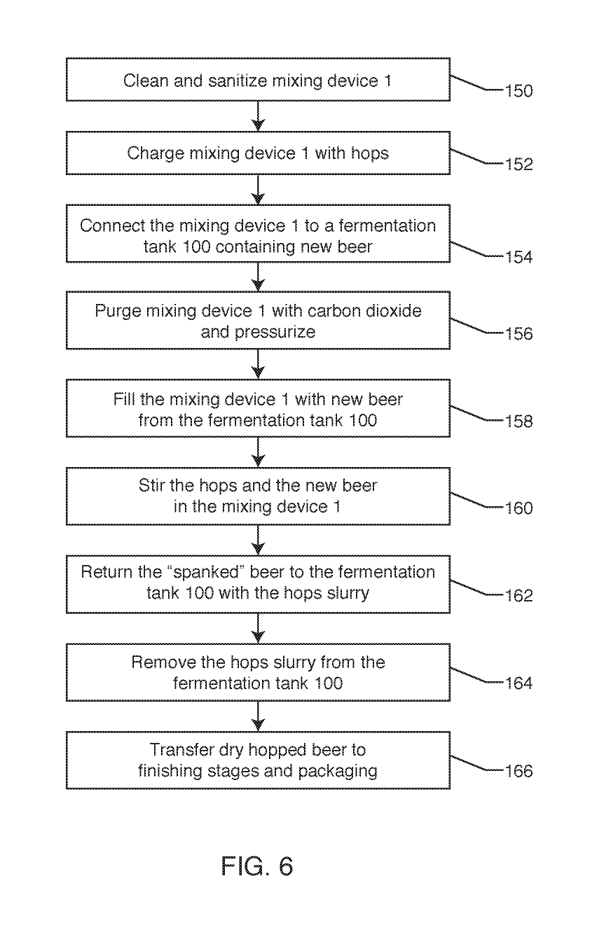

A currently preferred method of dry hopping according to the disclosed subject matter is illustrated in the block diagram of FIG. 6. FIGS. 5A-5C show a system for dry-hopping beer in various configurations. In each of these configurations the mixing device 1 connected to a fermentation tank 100 by a sanitary hose 112.

In step 150, the mixing device 1 is first cleaned and sanitized. The compartment 14 of the mixing vessel 10 is cleaned and sanitized by spraying cleaning solution through the CIP spray ball 60 inserted in the top port 15 while the bottom port 16 is connected via the bottom access pipe system 70 to a hose connected to a pump (the hose and the pump are not shown in the drawings). The valve 75 is opened to allow the cleaning solution to escape through the bottom access pipe system 70 to flow to the pump and then re-circulated back through the spray ball 60 in a closed loop system.

As mentioned earlier, the port 18 on the end wall 12 is useful for providing a vent when the vessel 10 is being cleaned to avoid excessive positive or negative pressures that could compromise the integrity of the vessel 10. The operator or brewer then flushes the compartment 14 by spraying sterilized water through the CIP spray ball 60 inserted in the top port 15 while the valve 75 is open to permit the water to escape from the compartment 14 through the bottom port 16.

In step 152, the mixing device 1 is charged with hops. The bottom port 16 of the mixing vessel 10 is closed while the funnel 50 is fixed to the top port 15. The brewer adds hop pellets (or hop flowers) H through the funnel 50 in the amount of the brewer's choosing. FIG. 5A shows hops pellets H inside the compartment 14 of the mixing vessel 10 as a result of the performance of this step.

In step 154, the mixing device 1 is to be connected with a sanitary hose 112 to a fermentation tank 100 containing young beer as shown in FIG. 5A. The mixing device 1 is moved by rolling on its wheels 34 to be near the fermentation tank 100. On the fermentation tank end of the sanitary hose 112 is a sight glass assembly 110 attached to a sanitary tee 105 with a valve 105A. The tee 105 is attached to a tank valve 104 that in turn is connected to the port 102 in the side of the fermentation tank 100. The other end of the sight glass 110 is attached to the sanitary hose 112. The sanitary hose 112 is clamped to the bottom access pipe system 70 that is connected to the bottom port 16 of the mixing vessel 10. The tank valve 104 will be closed until the mixing device is ready to be charged with new beer from the tank 100.

In step 156, the mixing device 1 is purged of air (oxygen). The configuration of the system for dry-hopping beer for purging is shown in FIG. 5A. The top port 15 of the mixing vessel 10 is sealed by clamping a pressure system 40, consisting of a pressure gauge 42, a carbon dioxide valve 44, and a pressure relief valve 46, to the flange 15a using a gasket (not shown) and the tri-clamp 17. The carbon dioxide gas supply 120 is connected to the valve 105A by a hose 122 connected to the intermediate carbon dioxide valve 105B. Opening the valve 105A and the carbon dioxide valve 105B permits carbon dioxide gas from the CO2 supply 120 to flow through the carbon dioxide valve 105B and the valve 105A and thence through the sight glass assembly 110 into the sanitary hose 112. From the sanitary hose 112 the carbon dioxide gas flows through the bottom access pipe system 70 and through the port 60 into the compartment 14 of the mixing vessel 10. The valve 104 is closed and the valve 75 is opened during this step in order to direct the carbon dioxide gas toward the mixing vessel 10.

The carbon dioxide gas is supplied from the carbon dioxide supply at up to ten pounds per square inch (PSI) pressure and is vented from the compartment 14 by cracking the carbon dioxide valve 44 as needed. Pressurizing to ten PSI and then venting the compartment 14 to zero PSI three times should be sufficient to eradicate any oxygen from the compartment 14 of the mixing vessel 10 as well as any residual oxygen in the hops H contained in the compartment 14.

In step 158, the mixing device 1 is filled with young beer from the fermentation tank 100. The configuration of the system for dry-hopping beer for filling the mixing tank 10 is shown in FIG. 5B. The valve 105A is closed. The valve 104 is opened and the valve 75 remains open in order to provide a path for young beer to flow from the fermentation tank 100 to the mixing vessel 10 due to a difference in pressure or gradient between the fermentation tank 100 and the compartment 14 of the vessel 10. The pressure at the time of filling preferably is ten PSI in the compartment 14 of the vessel 10, and approximately twelve PSI in the fermentation tank 100. The pressure in the fermentation tank 100 is supplied by connecting the CO2 supply 120 to the carbon dioxide addition pipe 108 via the hose 122 and the carbon dioxide valve 109 (which may be the same as the carbon dioxide valve 105B).

The pressure imbalance between the fermentation tank 100 and the mixing vessel 10 allows for adequate flow of new or young beer without excessive foaming. The carbon dioxide valve 44 is cracked open to vent off flow-restrictive excessive pressure in the compartment 14. The young beer B that enters the compartment 14 of the mixing vessel 10 preferably should be free of yeast slurry, therefore the side valve 104 and not the lower-positioned bottom valve 106 of the fermentation tank 100 should be used to fill the compartment 14. The young beer B that enters the compartment 14 of the mixing vessel 10 preferably should be at a temperature of greater than 60 degrees Fahrenheit to ensure the hop oil solubility is more nearly ideal. The hops or hops pellets H will now be immersed in the young beer B.

In step 160, the hops H and the young beer B in the compartment 14 of the mixing vessel are stirred in order to extract hop oil into the young beer. Once the compartment 14 of the mixing vessel 10 is full, the valve 75 is shut and the carbon dioxide valve 44 is shut after the pressure of the compartment 14 reaches between three and five PSI. The paddle 25 is adapted to stir the hops H into the beverage B and for this purpose the paddle 25 is shaped and sized to nearly touch but not contact the side wall 11 of the vessel 10 so that the hops H will be mobilized into the beverage B and not left resting on the bottom of the compartment 14.

The hops H may be stirred or “spanked” using the mixer handle 27 or a motor to rotate the mixing paddle apparatus 20 and thus the paddle 25 at a frequency and duration of the brewer's choosing, such as one revolution every two hours, until the brewer has either determined that maximum oils have been extracted from the hops by sensory evaluation (smell and taste) or by gas chromatography. Alternatively, the brewer may follow a schedule that has been previously determined in light of experience to extract the maximum oils from the hops in view of the nature of the hops and the young beer.

A speed and frequency of spanking could be programmed into the motor's control system if a mixing motor is used to stir the hops. For example, the control system could be programmed to spank or rotate the paddle every X hours for Y minutes for Z days.

In step 162, the “spanked” beer, along with the hop slurry that will have been created by stirring or spanking the hops with the young beer, are sent to the fermentation tank 100. The configuration of the system for dry-hopping beer for doing so is shown in FIG. 5C. The brewer pressurizes the compartment 14 of the vessel 10 of the mixing vessel 10 preferably to ten PSI, as seen on the gauge 42, by supplying carbon dioxide from the carbon dioxide supply 120 via the carbon dioxide supply hose 122 and the carbon dioxide valve 44. The brewer then sets the pressure of the fermentation tank 100 preferably to three PSI. The valve 75 of the bottom access pipe 70 attached to the mixing vessel 10 is opened along with the fermentation tank valve 104. (The valve 105A should remain closed.) The large pressure differential allows for flow back into the fermentation tank 100. The brewer rotates the paddle 25 in the compartment 14 of the vessel 10 of the mixing vessel 10 to ensure all the dry-hopped beer and the hop slurry is sent to the fermentation tank 100.

In step 164 the hops slurry is removed from the fermentation tank 100. To do so, the fermentation tank temperature of the fermentation tank 100 is dropped to a conditioning temperature (preferably in the range 30-32 degrees Fahrenheit) to settle out the hop slurry. The hop slurry is removed through the bottom valve 106 of the fermentation tank 100 after settling.

In step 166 the finished dry hopped beer will continue through to the brewer's downstream bright beer processing.

Depending on the size of the fermentation tank 100, one performance of the steps 150 through 164 may be sufficient to dry hop the young beer in the fermentation tank 100. In practice, one loading of a mixing device 1 having a capacity of 80 gallons of new beer with about 1.2 pounds of hops pellets, in the performance of the steps 150-164, is found to be sufficient to treat the young beer in a 700 gallon fermentation tank 100. A larger fermentation tank 100 may require the treatment of more new beer in the mixing device 1, and thus the steps 150-164 could be repeated if necessary to dry hop the new beer.

Should a larger fermentation tank 100 be employed, preferably two or more mixing devices 1 would be charged one after the other from the fermentation tank 100 with new beer and set to performing step 160 at the same time, followed by sequential performance of the step 162 with each mixing device 1. This is to save time in the brewing process because using the same mixing device 1 twice or more times over in sequence will take more time. Alternatively, a larger mixing device 1 could be employed.

The detailed description above has discussed a system, method, and device for dry hopping young beer. However, the skilled person will recognize that the same system, method, and device could be employed to add the aromatic component from an ingredient such as an adjunct to young beer or to any fermented beverage, such as cider.

This specification describes currently preferred embodiments of the disclosed subject matter. However, it will be understood that various modifications may be made thereto, and it is intended that the appended claims cover all such modifications as fall within the spirit and scope of the disclosed subject matter.

1. A method of adding an ingredient having aromatic components to a beverage contained in a fermentation tank, comprising:
providing a mixing device having a vessel defining a compartment and having a paddle in the compartment that may be moved,
charging the compartment of the mixing device with the ingredient,
providing fluid communication between the fermentation tank and the compartment of the mixing device,
purging the compartment of the mixing device and the fluid communication with an inert gas,
filling the compartment of the vessel of the mixing device with beverage from the fermentation tank,
stirring the ingredient and the beverage inside the compartment of the vessel of the mixing device by moving the paddle,
determining when a sufficient amount of aromatic components from the ingredient have been added to the beverage in the compartment of the vessel of the mixing device,
returning the beverage from the compartment of the vessel of the mixing tank to the fermentation tank together with a slurry formed from the ingredient in the compartment of the vessel of the mixing device.

2. The method according to claim 1 further comprising the step of sanitizing the compartment of the vessel of the mixing device prior to the step of charging the vessel of the mixing device with the ingredient.

3. The method according to claim 1 further comprising the step of removing the slurry from the fermentation tank.

4. The method according to claim 1 further comprising the step of transferring the beverage in the fermentation tank to downstream processing following the return of the beverage with the slurry from the compartment of the vessel of the mixing vessel.

5. The method according to claim 1 wherein the beverage is new beer and the ingredient is hops.

6. The method according to claim 5 wherein the hops are whole hops flowers or seed cones.

7. The method according to claim 5 wherein the hops are in the form of pellets.

8. The method according to claim 1 wherein the beverage is new beer and the ingredient is an adjunct.

9. The method according to claim 8 wherein the adjunct is selected from the group consisting of spices, herbs, extracts, and fruits.

10. The method according to claim 1 wherein the beverage is a cider.

11. A mixing device for adding an ingredient having aromatic components to a beverage, comprising:
a vessel having walls defining a compartment,
a paddle mounted on an axle inside the compartment and configured so that the paddle may be rotated by turning the axle, and
a top port and a bottom port being defined in the vessel for providing access to the inner compartment, wherein the top port is configured to receive the ingredient into the compartment and the bottom port is configured to receive into and discharge the beverage from the compartment.

12. The mixing device according to claim 11 wherein the top port is configured to receive any of the group consisting of a funnel, a pressure system comprising a pressure gauge, and a clean-in-place spray ball.

13. The mixing device according to claim 11 wherein the pressure system further comprises a pressure relief valve and a CO₂ valve.

14. The mixing device according to claim 11 further comprising a cart having wheels is attached to the vessel wherein the cart is configured to support the vessel and permit the vessel to be moved across a floor.

15. The mixing device according to claim 11 wherein the paddle is configured to rotate adjacent to but not in contact with the walls of the vessel whereby the ingredient will be stirred into the beverage.

16. The mixing device according to claim 11 further comprising a bottom access pipe system connected to and communicating with the bottom port whereby beverage may be supplied to and from the compartment of the vessel.

17. The mixing device according to claim 16 wherein the bottom access pipe system comprises a valve adapted to communicate with a hose for supplying the beverage to and from the compartment of the vessel.

18. A system for adding an ingredient having aromatic components to a beverage, comprising:
a tank having walls defining a compartment adapted to contain the beverage and a port in a lower part of the tank and a port in an upper part of the tank providing fluid communication with the compartment,
a mixing device comprising a vessel defining a compartment, a paddle mounted on an axle inside the compartment and configured so that the paddle may be rotated by turning the axle, and a top port and a bottom port being defined in the vessel for providing access to the compartment, wherein the top port is configured to receive the ingredient into the compartment of the mixing device and the bottom port is configured to receive into and discharge the beverage from the compartment of the mixing device,
a hose adapted to be connected to the lower port of the tank and the bottom port of the vessel of the mixing device for providing fluid communication between the compartment of the tank and the compartment of the vessel of the mixing device,
a source of compressed inert gas and a tube attached to the source for providing compressed inert gas to either the upper port of the tank or the top port of the vessel of the mixing device.

19. The system according to claim 18 further comprising a valve attached to the lower port of the tank wherein the hose is adapted to be connected to the valve.

20. The system according to claim 18 further comprising a valve attached to the bottom port of the vessel of the mixing device wherein the hose is adapted to be connected to the valve.

21. The system according to claim 19 further comprising a sight glass attached to the valve that is attached to the lower port of the tank.
